(19) United States
(12) Patent Application Publication
(10) Pub. No.: US 2013/0257926 A1
(43) Pub. Date: Oct. 3, 2013

(54) DRIVING METHOD FOR DRIVER CHIP AND DISPLAY METHOD FOR STEREOSCOPIC DISPLAY DEVICE

(71) Applicant: HANNSTAR DISPLAY CORP., New Taiepi City (TW)

(72) Inventors: Chih-Hsuan Lee, Tainan City (TW); Chun-Chin Tseng, Kaohsiung City (TW)

(73) Assignee: HANNSTAR DISPLAY CORP., New Taipei City (TW)

(21) Appl. No.: 13/741,387

(22) Filed: Jan. 15, 2013

(30) Foreign Application Priority Data
Mar. 28, 2012 (CN) 201210086732.8

(51) Int. Cl. G09G 3/18

(52) U.S. Cl. CPC G09G 3/18
USPC 345/691; 345/88

(57) ABSTRACT

The present invention provides a display method for a stereoscopic display device. First, a frame formed by a left-eye frame with a first color and a right-eye frame with a second color different from the first color is generated with a liquid crystal panel. A first light source emitting a first light beam of the first color and a second light source emitting a second light beam of the second color of the stereoscopic display device are turned on. The first light beam and the second light beam are guided separately toward the liquid crystal panel with the directional light guide plate. When the liquid crystal panel generates the frame, the first light beam and the second light beam penetrate the liquid crystal panel separately, and the left-eye frame and the right-eye frame are displayed at a first view angle and a second view angle respectively.

### BACKGROUND OF THE INVENTION

1. Field of the Invention

The present invention relates to a driving method for a driver chip and a display method for a stereoscopic display device, and more particularly, to a driving method for a driver chip and a display method for a stereoscopic display device to display a stereoscopic image without wearing glasses.

2.Description of the Prior Art

As information technology develops rapidly, the demand for innovative display techniques not only is to display high quality images, but also is to display stereoscopic and more real images. In general, the stereoscopic display technologies may be substantially divided into two major types, which are the glasses type and the naked eye type (auto stereoscopic type). However, the basic technique of the two types of the stereoscopic display technology is to present different frames that are displayed separately to the left and right eye. Both of these 2D frames are then combined in the brain to give the perception of 3D depth.

Take the glasses type stereoscopic display device as an example. An image process is carried out with an imaging device to form a superimposed image of a reddish frame and a bluish frame. The reddish frame is for the left-eye frame; the bluish frame is for the right-eye frame. As the superimposed image penetrates a red glass of the anaglyph glasses, the viewer can see a reddish left-eye frame. As the superimposed image penetrates a blue glass of the anaglyph glasses, the viewer can see a bluish left-eye frame. Therefore, the viewer can see the stereoscopic image with color offset; however, this method still requires wearing glasses, and thus inconveniences a viewer. Currently, there is a stereoscopic display method using the directional light guide plate combined with a time-sequential method to display the left-eye frame and the right-eye frame. However, displaying the left-eye frame and the right-eye frame with the time-sequential method could increase the frequency of a stereoscopic image and burden the driver chip.

Accordingly, how to display the stereoscopic image for the naked eye without raising the display frequency of the liquid crystal panel is a main objective in the field.

### SUMMARY OF THE INVENTION

It is one of the objectives of the invention to provide a driving method for a driver chip and a display method for a stereoscopic display device. This method can prevent the display frequency of the liquid crystal panel from increasing, and display a stereoscopic image for the naked eye.

To achieve the purposes described above, an embodiment of the invention provides a display method for a stereoscopic display device. The method includes the following steps. Generate a frame with a liquid crystal panel of the stereoscopic display device. Moreover, the frame is formed by a left-eye frame with a first color and a right-eye frame with a second color different from the first color. A first light source and a second light source of the stereoscopic display device are turned on. The first light source emits a first light beam of the first color, and the second light source emits a second light beam of the second color. The first light source and the second light source are disposed on two opposite sides of a directional light guide plate of the stereoscopic display device respectively. Guide the first light beam and the second light beam separately toward the liquid crystal panel with the directional light guide plate. When the liquid crystal panel generates the frame, the first light beam and the second light beam penetrate the liquid crystal panel separately, and the left-eye frame and the right-eye frame are displayed at a first view angle and a second view angle respectively.

To achieve the purposes described above, an embodiment of the invention provides a driving method for a driver chip. The method includes the following steps. An image signal is output to the driver chip. Then, output an frame signal to the liquid crystal panel with a driver chip of the stereoscopic display device in order to generating the frame. In order to turn on the first light source and the second light source when the frame is generated, a first switching signal is output to the first light source and a second switching signal is output to the second light source. And the frame signal has a driving period and a stabilization period. The first switching signal has a first turn-on period and a first turn-off period; the second switching signal has a second turn-on period and a second turn-off period. The first turn-on period and the second turn-on period are, at least, overlapping the stabilization period.

To sum up, the display method for the stereoscopic display device of the present invention is to coordinate the timing when the first light source and the second light source are turned on and the timing when the frame is generated by the liquid crystal panel. Thus, the frequency of displaying a stereoscopic image is the same as the frequency of generating a frame by the liquid crystal panel. Also, since the stereoscopic image should be displayed by generating two continuous frames with liquid crystal panel in the prior art, the display method of the present invention can prevent the display frequency of the liquid crystal panel from increasing due to the two-continuous-frames demand of the stereoscopic image, and lighten the load of the driver chip.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a stereoscopic display device according to an embodiment of the present invention in the cross-section view.

FIG. 2 is a flow schematic diagram illustrating a display method for a stereoscopic display device according to a first embodiment of this invention.

FIG. 3 is a schematic diagram illustrating a frame displayed by a liquid crystal panel.

FIG. 4 is a flow schematic diagram illustrating a driving method for a driver chip according to the first embodiment of this invention.

FIG. 5 is a schematic diagram illustrating the stereoscopic display device according to the first embodiment of this invention.

FIG. 6 is a timing schematic diagram illustrating a signal input from a driver chip to the first light source, the second light source, and the liquid crystal panel according to the first embodiment of this invention.

FIG. 7 is a timing schematic diagram illustrating a signal input from a driver chip to the first light source, the second light source, and the liquid crystal panel according to a second embodiment of this invention.

FIG. 8 is a timing schematic diagram illustrating a signal input from a driver chip to the first light source, the second light source, and the liquid crystal panel according to a third embodiment of this invention.

FIG. 9 is a timing schematic diagram illustrating a signal input from a driver chip to the first light source, the second light source, and the liquid crystal panel according to a fourth embodiment of this invention.

### DETAILED DESCRIPTION

To provide a better understanding of the present invention to users skilled in the technology of the present invention, the embodiments will be made in detail. The embodiments of the present invention are illustrated in the accompanying drawings with numbered elements to clarify the contents and effects to be achieved. In addition, the terms such as “first” and “second” described in the present invention are used to distinguish different components or processes, which do not limit the sequence of the components or processes.

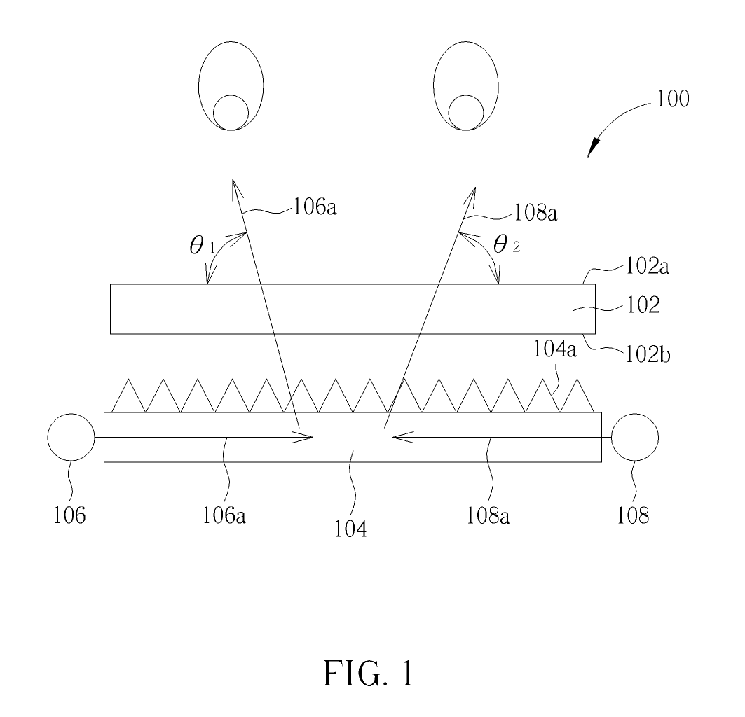

Please refer to FIG. 1. FIG. 1 is a schematic diagram illustrating a cross-section view of a stereoscopic display device 100 according to an embodiment of the present invention. As shown in FIG. 1, the stereoscopic display device 100 includes a liquid crystal panel 102, a directional light guide plate 104, a first light source 106, and a second light source 108. The liquid crystal panel 102 has a display surface 102a and a light incident surface 102b opposite to the display surface 102a. The liquid crystal panel 102 can be used to display a frame. The directional light guide plate 104 is disposed on the light incident surface 102b of the liquid crystal panel 102. The first light source 106 and the second light source 108 are disposed on two opposite sides of a directional light guide plate 104 of the stereoscopic display device 100 respectively, that is to say that the directional light guide plate 104 is disposed between the first light source 106 and the second light source 108.

The first light source 106 can emit a first light beam 106a and the second light source 108 can emit a second light beam 108a; therefore, the first light source 106, the second light source 108, and the directional light guide plate 104 can be used as a back light source of the liquid crystal panel 102. In this embodiment, the first light source 106 and the second light source 108 may be light bars, and each of the light bars is consisting of a plurality of light emitting diodes, but not limited thereto. The first light beam 106a has a first color, and the second light beam 108a has a second color different from the first color. Preferably, the first color and the second color may be mixed to be white light, but not limited thereto. In this embodiment, the first color, for example, may be red and the second color, for example, may be cyan or blue-green, but not limited thereto. In other embodiments, the first color and the second color can also be orange and azure, or blue and yellow respectively. The directional light guide plate 104 in this embodiment has a plurality of micro-structures 104a, for example a prism structure, disposed on a surface of the directional light guide plate 104 facing the liquid crystal panel 102.

After the first light beam 106a emitted from the first light source 106 disposed on a side of the directional light guide plate 104 enters the directional light guide plate 104, the directional light guide plate 104 will guide the first light beam 106a toward the liquid crystal panel 102. After the second light beam 108a emitted from the second light source 108 disposed on the other side of the directional light guide plate 104 enters the directional light guide plate 104, the directional light guide plate 104 will guide the second light beam 108a toward the liquid crystal panel 102. After the first light beam 106a and the second light beam 108a pass through the liquid crystal panel 102, the first light beam 106a and the second light beam 108a will be emitted toward a viewer at a first view angle θ₁ and a second view angle θ₂ respectively. Therefore, the left eye and the right eye of the viewer can receive the first light beam 106a and the second light beam 108a respectively.

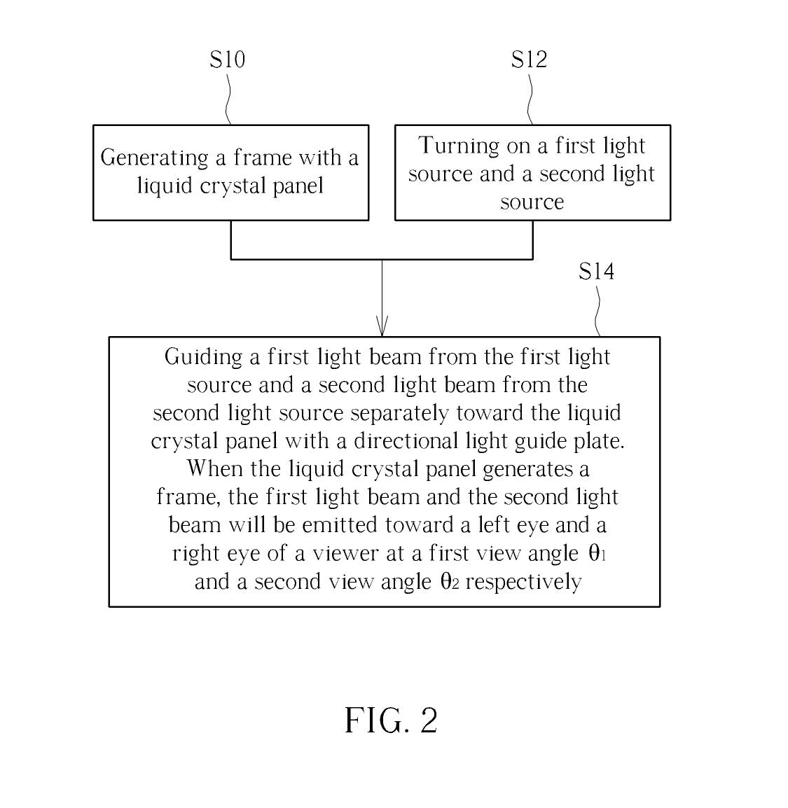

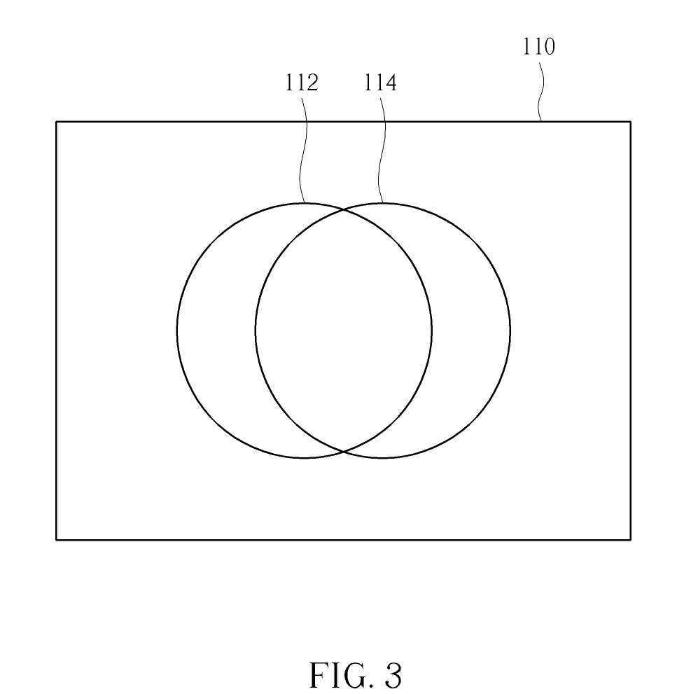

The following further illustrate a display method for the stereoscopic display device 100 of this embodiment. Please refer to FIGS. 2-3 and FIG. 1. FIG. 2 is a flow chart illustrating the display method for the stereoscopic display device according to a first embodiment of the present invention. FIG. 3 is a schematic diagram illustrating a frame displayed by the liquid crystal panel 102. As shown in FIGS. 1-3, the display method for the stereoscopic display device 100 includes:

Step S10: generating a frame 110 with the liquid crystal panel 102;

Step S12: turning on the first light source 106 and the second light source 108; and

Step S14: guiding the first light beam 106a from the first light source 106 and the second light beam 108a from the second light source 108 separately toward the liquid crystal panel 102 with the directional light guide plate 104. When the liquid crystal panel 102 generates the frame 110, the first light beam 106a and the second light beam 108a will be emitted toward the left eye and the right eye of a viewer at the first view angle θ₁ and the second view angle θ₂ respectively.

In the step S10, the frame 110 generated by the liquid crystal panel 102 is formed by the left-eye frame 112 with red color and the right-eye frame 114 with cyan color in this embodiment. The colors of the left-eye frame and the right-eye frame of the present invention are not limited to red and cyan, and they can also be orange and azure, or blue and yellow. The colors of the left-eye frame and the right-eye frame of the present invention may be the same as the colors of the first light beam 106a and the second light beam 108a respectively. The liquid crystal panel 102 includes a plurality of pixels (not shown), and each pixel includes at least three sub pixels (not shown), namely a red sub pixel, a blue sub pixel, and a green sub pixel. Consequently, the left-eye frame 112 may be displayed with the red sub pixels of all the pixels, and the right-eye frame 114 may be displayed with blue and the green sub pixels of all the pixels. The color of the sub pixels of the present invention is not limited to red, blue, and green. In other embodiments, they may further comprise white, yellow, and/or magenta. The first color of the present invention may be the mixed color of two sub pixels of each pixel, and the second color of the present invention may be the color of other sub pixel of each pixel.

In the step S12, the first light source 106 and the second light source 108 are turned on in order to emit the first light beam 106a and the second light beam 108a into the directional light guide plate 104. The first light source 106 and the second light source 108 may be turned on simultaneously or separately.

In the step S14, the first light beam 106a and the second light beam 108a emitted into the two opposite sides of the directional light guide plate 104 are separately guided toward the liquid crystal panel 102 by the directional light guide plate 104. When the liquid crystal panel 102 generates the frame 110, the first light beam 106a and the second light beam 108a will penetrate the liquid crystal panel 102 and then reach the left eye and the right eye of the viewer respectively. In the liquid crystal panel 102, the red sub pixels may include red filters (not shown), the green sub pixels may include green filters (not shown), and the blue sub pixels may include blue filters (not shown). When the first light beam 106a with red color passes through the liquid crystal panel 102, the first light beam 106a only penetrates red filter but is blocked by green and blue filters (or does not penetrate green and blue filters). When the second light beam 108a with cyan color passes through the liquid crystal panel 102, the second light beam 108a only penetrates green and blue filters but is blocked by red filter (or does not penetrate red filter). Therefore, as the first light beam 106a and the second light beam 108a penetrate the liquid crystal panel 102, the first light beam 106a with the information of the left-eye frame 112 may be emitted to the viewer's left eye at the first view angle θ₁, and the second light beam 108a with the information of the right-eye frame 114 may be emitted to the viewer's right eye at the second view angle θ₂. Then, the left-eye frame 112 and the right-eye frame 114 are displayed at the first view angle θ₁ and the second view angle θ₂ respectively. The left-eye frame 112 with red color and the right-eye frame 114 with cyan color reach the left and right eye respectively. The brain fuses the frames into perception of a colorful three dimensional scene integrating the left-eye frame 112 with red color and the right-eye frame 114 with cyan color.

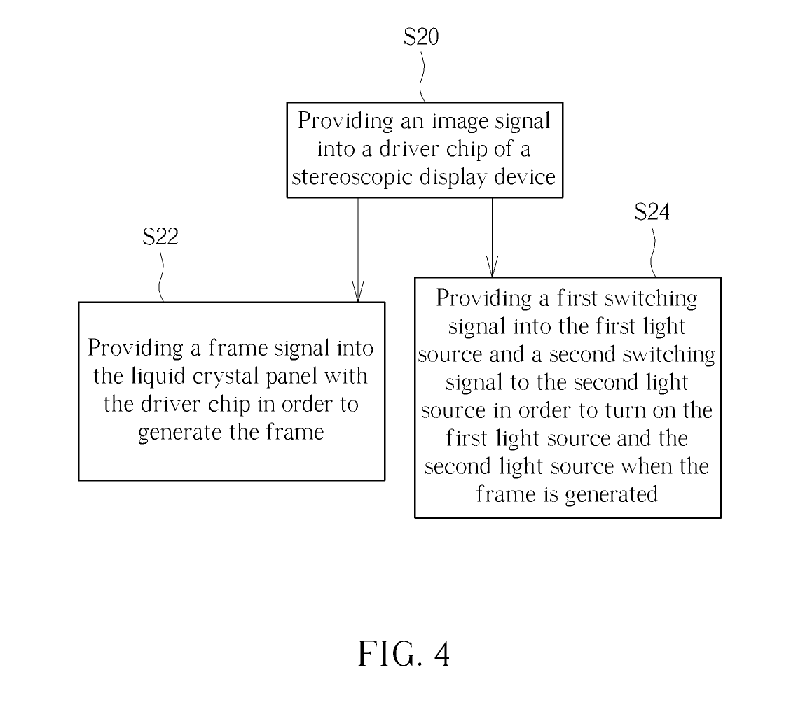

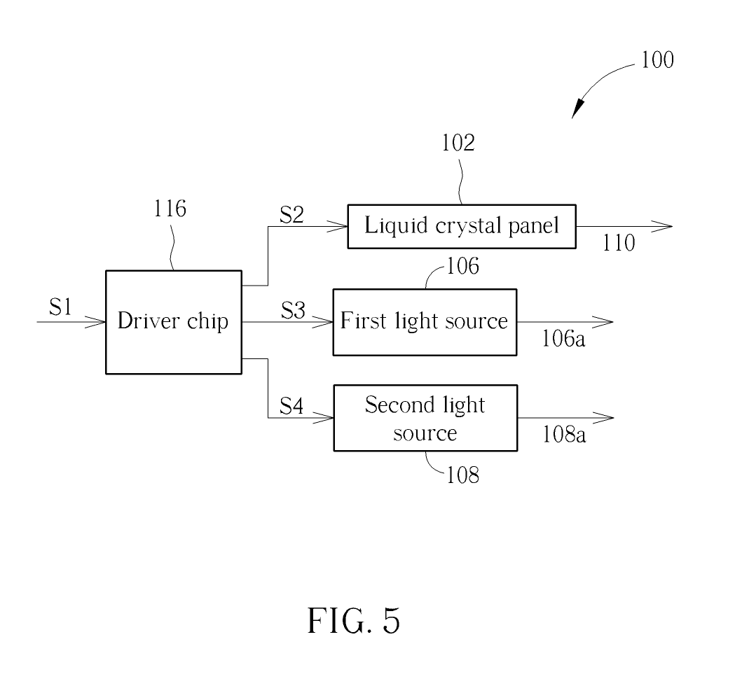

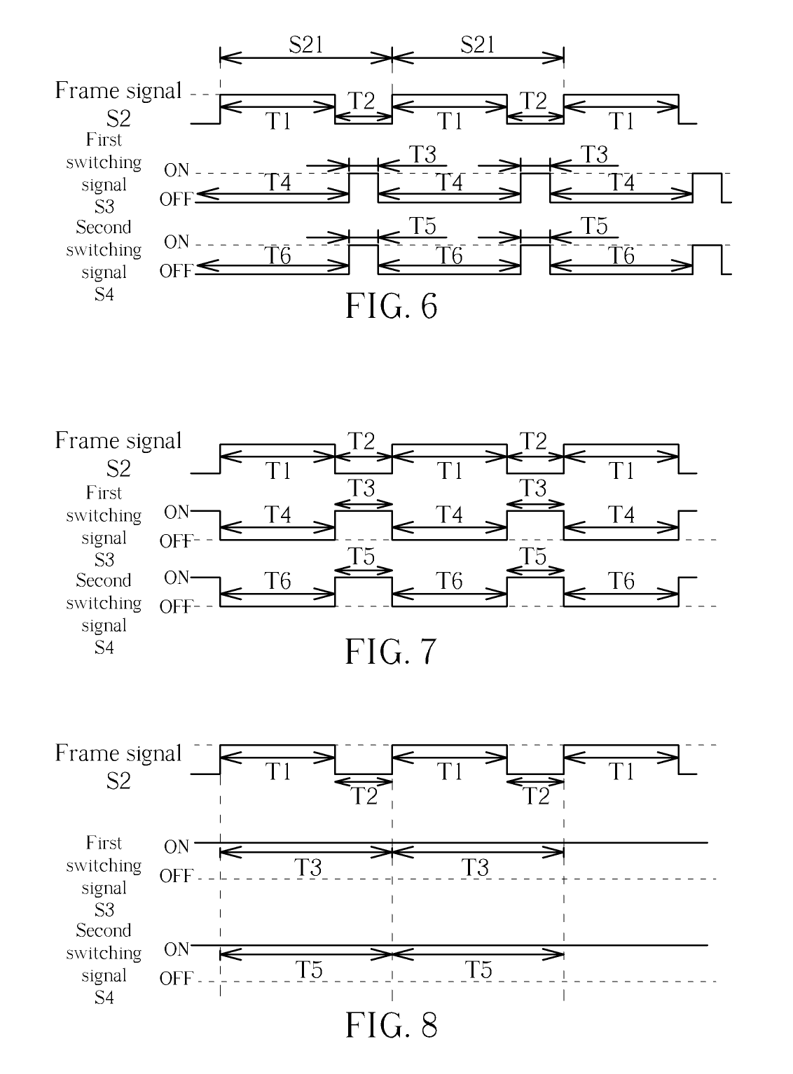

Before the frame 110 is generated and the first light source 106 and the second light source 108 are turned on, the display method for the stereoscopic display device 100 further includes a driving method for a driver chip 116. Please refer to FIGS. 4-6. FIG. 4 is a flow chart illustrating a driving method for a driver chip 116 according to the first embodiment of this invention. FIG. 5 is a schematic diagram illustrating the stereoscopic display device according to the first embodiment of this invention. FIG. 6 is a timing schematic diagram illustrating a signal input from the driver chip 116 to the first light source, the second light source, and the liquid crystal panel according to the first embodiment of this invention. As shown in FIGS. 4-5, the stereoscopic display device 100 further includes the driver chip 116. The driver chip 116 is electrically connected to the liquid crystal panel 102, the first light source 106, and the second light source 108. The driver chip 116 may include many types of circuits having different functions to process received image signals S1, but not limited thereto. The driving method for the driver chip 116 includes:

Step S20: providing an image signal S1 into the driver chip 116 of the stereoscopic display device 100;

Step S22: providing a frame signal S2 into the liquid crystal panel 102 with the driver chip 116 in order to generate the frame 110; and

Step S24: providing a first switching signal S3 into the first light source 106 and a second switching signal S4 to the second light source 108 in order to turn on the first light source 106 and the second light source 108 when the frame 110 is generated.

In the step S20, the image signal S1 may be generated by a video source, such as set top boxes, disc players, and cameras, but not limited thereto. In the step S22, after the driver chip 116 receives the image signal S1, the driver chip 116 will convert the image signal S1 into the frame signal S2 to drive the liquid crystal panel 102. By transmitting the frame signal S2 to the liquid crystal panel 102, the liquid crystal panel 102 then generates the frame 110. In the step S24, after the driver chip 116 receives the image signal S1, the driver chip 116 will convert the image signal S1 into the first switching signal S3 and the second switching signal S4 to drive the first light source 106 and the second light source 108. When the frame 110 is generated, by transmitting the first switching signal S3 and the second switching signal S4 to the first light source 106 and the second light source 108 respectively, the first light source 106 emits the first light beam 106a and the second light source 108 emits the second light beam 108a. By doing so and coordinating the timing for the liquid crystal panel 102 to generate the frame and the timing to emit the first light beam 106a and the second light beam 108a, the stereoscopic display device 100 then display the stereoscopic image.

As shown in FIG. 6, when generating a single frame 110, the frame signal S2 has a driving period T1 and a stabilization period T2; that is to say, a single frame signal S21 includes a single driving period T1 and a single stabilization period T2, and the frame signal S2 may include a plurality of the single frame signals S21 including the driving period T1 and the stabilization period T2. The driving period T1 and the stabilization period T2 are initiated alternatively and in order. In each of the driving periods T1, the driver chip 116 sends the information of the frame 110 to the liquid crystal panel 102, and the liquid crystal panel 102 scans the information of the frame 110 to generate the frame 110 in this period. In the following stabilization period T2, the completed frame 110 stay on the liquid crystal panel 102. Until the next driving period T1 initiates, the next frame 110 is displayed on the liquid crystal panel 102.

The first switching signal S3 has a plurality of the first turn-on periods T3 and a plurality of the first turn-off periods T4. Each of the first turn-on periods T3 and each of the first turn-off periods T4 are initiated alternatively and in order. The second switching signal S4 has a plurality of the second turn-on periods T5 and a plurality of the second turn-off periods T6. Each of the second turn-on periods T5 and each of the second turn-off periods T6 are initiated alternatively and in order. In each of the first turn-on periods T3 and each of the second turn-on periods T5, the driver chip 116 produces turn-on signal ON to the first light source 106 and the second light source 108 in order to emit the first light beam 106a and the second light beam 108a. In each of the first turn-off periods T4 and each of the second turn-off periods T6, the driver chip 116 produces turn-off signal OFF to the first light source 106 and the second light source 108 in order to stop emitting the first light beam 106a and the second light beam 108a.

In this embodiment, the first switching signal S3 and the second switching signal S4 are synchronized; that is to say, the first turn-on period T3 and the second turn-on period T5 start and end simultaneously, and the first turn-off period T4 and the second turn-off period T6 start and end simultaneously. Consequently, the first light source 106 and the second light source 108 may be turned on and off simultaneously. The frame signal S2 is also synchronized with the first switching signal S3 and the second switching signal S4; the frame signal S2, the first switching signal S3 and the second switching signal S4 have the same frequency, for example 60 Hz or 120 Hz. When each of the frames 110 is displayed, the first turn-on period T3 and the second turn-on period T5 are overlapping the stabilization period T2, and the first turn-on period T3 and the second turn-on period T5 are shorter than the stabilization period T2, respectively. As a result, when the completed frame 110 stays on the liquid crystal panel 102, the first light source 106 and the second light source 108 are turned on to emit the first light beam 106a and the second light beam 108a; therefore, the left-eye frame 112 and the right-eye frame 114 are displayed. In other embodiments of this invention, the first switching signal S3 and the second switching signal S4 are not necessary to be synchronized; the first turn-on period T3 and the second turn-on period T5 are not necessary to start and end simultaneously.

Please refer to FIG. 1, FIG. 3, and FIG. 5. To sum up, the display method for the stereoscopic display device 100 of this embodiment is characterized by the following feature: the first light beam 106a and the second light beam 108a separately emitted from the directional light guide plate 104, the first light source 106 and the second light source 108 turned on by the driver chip 116, and the left-eye frame 112 and the right-eye frame 114 displayed at a first view angle θ₁ and a second view angle θ₂ respectively. By doing so, the frequency of displaying a stereoscopic image and the frequency of generating a frame by the liquid crystal panel 102 are the same. Therefore, the display method for the stereoscopic display device 100 of this embodiment can effectively maintain the display frequency of the liquid crystal panel 102, even only to the frequency that can be distinguished by human eyes. Also, since the stereoscopic image should be displayed by generating two continuous frames with liquid crystal panel in the prior art, the display method of this embodiment can prevent the display frequency of the liquid crystal panel 102 from increasing due to the two-continuous-frames demand of the stereoscopic image, and lighten the load of the driver chip 116. The display method for the stereoscopic display device 100 of this embodiment also enables the viewer to see the colorful stereoscopic image wearing glasses, or with the naked eye.

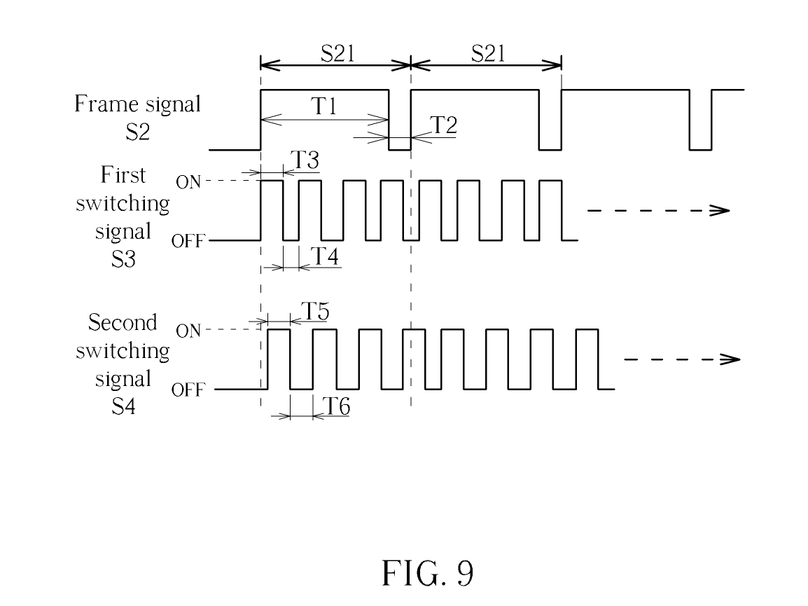

The first switching signal S3 and the second switching signal S4 of the first light source 106 and the second light source 108 are not limited to the above embodiments of this invention. Please refer to FIGS. 7-9. FIG. 7 is a timing schematic diagram illustrating a signal input from the driver chip to the first light source, the second light source, and the liquid crystal panel according to a second embodiment of this invention. FIG. 8 is a timing schematic diagram illustrating a signal input from the driver chip to the first light source, the second light source, and the liquid crystal panel according to a third embodiment of this invention. FIG. 9 is a timing schematic diagram illustrating a signal input from the driver chip to the first light source, the second light source, and the liquid crystal panel according to a fourth embodiment of this invention.

As shown in FIG. 7, the first turn-on period T3 of the first switching signal S3 and the second turn-on period T5 of the second switching signal S4 equal the stabilization period T2, respectively. The first turn-off period T4 of the first switching signal S3 and the second turn-off period T6 of the second switching signal S4 equal the driving period T1, respectively. That is to say, when the liquid crystal panel 102 finishes scanning the frame and displays the completed frame, the first light source 106 and the second light source 108 are turned on. In other embodiments of this invention, a sum of the first turn-on period T3 and the first turn-off period T4 is shorter than or equals a sum of the driving period T1 and the stabilization period T2. A sum of the first turn-on period T3 and the first turn-off period T4 may not equal a sum of the second turn-on period T5 and the second turn-off period T6.

As shown in FIG. 8, the first turn-on period T3 of the first switching signal S3 and the second turn-on period T5 of the second switching signal S4 equal a sum of the driving period T1 and the stabilization period T2, respectively. The first turn-off period T4 is unrelated to the first switching signal S3. The second turn-off period T6 is unrelated to the second switching signal S4. The first turn-off period T4 and the second turn-off period T6 equal zero respectively. That is to say, the first light source 106 and the second light source 108 are kept turned-on, and the first light source 106 and the second light source 108 are not turned off. This invention is not limited thereto. The first turn-on period of the first switching signal and the second turn-on period of the second switching signal of the present invention may at least overlap the stabilization period, and are overlapping the stabilization period. Thus, when the liquid crystal panel 102 displays the completed frame, the first light source 106 and the second light source 108 are turned on to display the completed stereoscopic image.

As shown in FIG. 9, a sum of each of the first turn-on periods T3 of the first switching signal S3 and each of the first turn-off periods T4 of the first switching signal S3 is less than a sum of the driving period T1 and the stabilization period T2. A sum of each of the second turn-on periods T5 of the second switching signal S4 and each of the second turn-off periods T6 of the second switching signal S4 is less than a sum of the driving period T1 and the stabilization period T2. A sum of each of the first turn-on periods T3 of the first switching signal S3 and each of the first turn-off periods T4 of the first switching signal S3 does not equal a sum of each of the second turn-on periods T5 of the second switching signal S4 and each of the second turn-off periods T6 of the second switching signal S4. Therefore, the first turn-on period T3 of the first switching signal S3 and the second turn-on period T5 of the second switching signal S4 do not end at the same time. The first turn-off period T4 of the first switching signal S3 and the second turn-off period T6 of the second switching signal S4 do not end at the same time.

To sum up, the display method for the stereoscopic display device of the present invention is to coordinate the timing when the first light source and the second light source are turned on and the timing when the frame is generated by the liquid crystal panel. Thus, the frequency of displaying a stereoscopic image is the same as the frequency of generating a frame by the liquid crystal panel. Also, since the stereoscopic image should be displayed by generating two continuous frames with liquid crystal panel in the prior art, the display method of the present invention can prevent the display frequency of the liquid crystal panel from increasing due to the two-continuous-frames demand of the stereoscopic image, and lighten the load of the driver chip. With the directional light guide plate, the display method for the stereoscopic display device of this embodiment also enables the viewer to see the colorful stereoscopic image without wearing glasses, or with the naked eye.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display method for a stereoscopic display device, comprising:
generating a frame with a liquid crystal panel of the stereoscopic display device, wherein the frame is formed by a left-eye frame with a first color and a right-eye frame with a second color different from the first color;
turning on a first light source and a second light source of the stereoscopic display device, wherein the first light source emits a first light beam of the first color, the second light source emits a second light beam of the second color, and the first light source and the second light source are disposed on two opposite sides of a directional light guide plate of the stereoscopic display device respectively.
guiding the first light beam and the second light beam separately toward the liquid crystal panel with the directional light guide plate, wherein when the liquid crystal panel generates the frame, the first light beam and the second light beam penetrate the liquid crystal panel separately, and the left-eye frame and the right-eye frame are displayed at a first view angle and a second view angle respectively.

2. The display method for the stereoscopic display device according to claim 1, further comprising providing a frame signal to the liquid crystal panel with a driver chip of the stereoscopic display device to generate the frame, and providing a first switching signal to the first light source and a second switching signal to the second light source to turn on the first light source and the second light source before the frame is generated and the first light source and the second light source are turned on.

3. The display method for the stereoscopic display device according to claim 2, wherein the first switching signal and the second switching signal are synchronized.

4. The display method for the stereoscopic display device according to claim 2, wherein when the frame is generated, the frame signal has a driving period and a stabilization period, the first switching signal has a first turn-on period and a first turn-off period, the second switching signal has a second turn-on period and a second turn-off period, and the first turn-on period and the second turn-on period are, at least, overlapping the stabilization period.

5. The display method for the stereoscopic display device according to claim 4, wherein the first turn-on period and the second turn-on period are shorter than or equal the stabilization period, respectively.

6. The display method for the stereoscopic display device according to claim 4, wherein the first turn-off period and the second turn-off period equal zero respectively.

7. The display method for the stereoscopic display device according to claim 4, wherein a sum of the first turn-on period and the first turn-off period is shorter than or equals a sum of the driving period and the stabilization period.

8. The display method for the stereoscopic display device according to claim 4, wherein a sum of the second turn-on period and the second turn-off period is shorter than or equals the sum of the driving period and the stabilization period.

9. The display method for the stereoscopic display device according to claim 4, wherein a sum of the first turn-on period and the first turn-off period does not equal the sum of the second turn-on period and the second turn-off period.

10. The display method for the stereoscopic display device according to claim 1, wherein the first color and the second color are red and cyan, orange and azure, or blue and yellow respectively.

11. A driving method for a driver chip, which comprises:
providing an image signal into the driver chip;
providing an frame signal into the liquid crystal panel with a driver chip of the stereoscopic display device in order to generating the frame; and
providing a first switching signal into the first light source and a second switching signal to the second light source in order to turn on the first light source and the second light source when the frame is generated, wherein the frame signal has a driving period and a stabilization period, the first switching signal has a first turn-on period and a first turn-off period, the second switching signal has a second turn-on period and a second turn-off period, and the first turn-on period and the second turn-on period are, at least, overlapping the stabilization period.
